(19) United States
(12) Patent Application Publication
(10) Pub. No.: US 2009/0051229 A1
(43) Pub. Date: Feb. 26, 2009

(54) ELECTRICAL POWER GENERATORS

(76) Inventor: Albert Shau, Palo Alto, CA (US)

Correspondence Address: JENG-JYE SHAU, 991 AMARILLO AVE., PALO ALTO, CA, 94303, US

(21) Appl. No.: 12/042,327

(22) Filed: Mar. 4, 2008

Related U.S. Application Data
(63) Continuation-in-part of application No. 11/309,530, filed on Aug. 18, 2006, now abandoned.
Application No. 11/309,530 is a continuation-in-part of application No. 11/162,285, filed on Sep. 5, 2005, now Pat. No. 7,148,583.

(51) Int. Cl. H02K 35/00

(52) U.S. Cl. 310/15

(57) ABSTRACT

The present invention provides methods to convert motion into electrical energy. These electrical power generators are made compatible with standard batteries so that they can support operations of existing battery powered portable appliances with no or minimal modifications. Electrical power generators of the present invention are therefore more convenient to use than conventional batteries while reducing the needs to replace or recharge batteries. Environment friendly methods are also introduced for generating electrical power.

This application is a continuation in part application of another co-pending Patent Application with a Ser. No. 11/309,530 titled “ELECTRICAL POWER GENERATORS” and filed by the applicants on Aug. 18, 2006. 11/309,530 application is a continuation in part application of patent application Ser. No. 11/162,285 filed by the applicants on Sep. 05, 2005. The 11/162,285 application was granted as U.S. Pat. No. 7,148,583 on Nov. 22, 2006.

### DESCRIPTION

### BACKGROUND OF THE INVENTION

The present invention relates to electrical power generators, and more particularly to electrical power generators that are compatible with battery powered portable appliances.

Current art portable electrical appliances, such as flash lights, remote controllers, pagers, cellular phones and laptop computers, require batteries as their power sources. Compared to electrical appliances that require power cords, these portable appliances are far more convenient to use. However, batteries run out of charge, limiting the time one can use certain appliances. Cameras run out of batteries when pictures need to be taken. Laptops shut down during important presentations. The constant need to replace or to re-charge drained batteries is therefore a source of inconvenience for current art portable electrical appliances.

Many inventions have been developed to address this problem. Campagnuolo et al. disclosed a portable hand-cranked electrical power generator in U.S. Pat. No. 4,227,092, and a leg driven power generator in U.S. Pat. No. 4,746,806. Those power generators were “lightweight” at the time of the inventions, but are far too heavy for today's portable appliances. In U.S. Pat. No. 5,905,359, Jimena disclosed a relatively small electrical power generator installed in a flash light. This power generator used the batteries in the flash light as a flying wheel to store kinetic energy, and used magnetism to convert rotational motion of the flying wheel into electrical energy. Users must purchase special apparatuses installed with rotational batteries and power generators in order to utilize Jimena's invention. In U.S. Pat. No. 6,220,719, Vetrorino disclosed another method to build a renewable energy flashlight. Vetrorino's flashlight used a power generator that is similar to one of the example (FIG. 1) in the present invention. However, the power generator is attached to the flash light in Vetrorino patent so that users must purchase the whole flash light in order to utilize Vetrorino invention; the same power generator is not useful for other appliances. Haney et al. disclosed a manually-powered portable power generator. The apparatus comprises of a manually operable air pump that provides a compressed flow of air used to rotate an electrical power generator. Users must use a specially designed air pump and power generator to use the invention.

These inventions are all valuable methods to provide electrical power. However, none of them have been widely used. The major reason is that they miss the key value of portable appliances. The most important advantage of portable appliances is convenience. If the users need to purchase special apparatuses or wear special gears to charge portable devices, the additional inconvenience defeats the original purpose of portable appliances. Most users would rather use conventional batteries because of availability and convenience. To be popularly used, portable power generators must be made more convenient to use than conventional batteries. In order to achieve those goals, we believe that portable electrical power generators must be compatible with existing battery powered appliances. Such power generators should be as easy to use as conventional batteries, and be more convenient to replace or recharge.

Batteries have other problems. Much more energy is used to manufacture batteries than actually provided by the battery. When batteries are used up and discarded, the chemicals in the batteries pollute the environment. Typical battery usage is therefore a terrible pollution source. There are environment-friendly methods of generating electrical power such as solar cells or wind mills. Van Breems disclosed an apparatus to convert tidal energy into electrical energy in U.S. Pat. No. 6,833,631. However, these environment-friendly methods provide insignificant amounts of energy compared to overall energy consumption. Due to cost considerations, human beings are still burning oil, building dams, building nuclear power plants, and using energy-inefficient batteries, polluting the planet to feed energy-hungry human societies. Although those environment-friendly methods have been available for decades, they will not be fully utilized unless their cost is comparable to polluting methods. It is therefore highly desirable to provide cost efficient, environmentally friendly energy sources.

### SUMMARY OF THE INVENTION

The primary objective of this invention is, therefore, to provide portable electrical power generators that are more convenient to use than conventional batteries. The other primary objective of this invention is to provide cost-efficient and environment-friendly methods of generating electrical power. These and other objectives are achieved by providing electrical power generators that are compatible to conventional batteries and by providing environment-friendly methods of building electrical power generators.

While the novel features of the invention are set forth with particularly in the appended claims, the invention, both as to organization and content, will be better understood and appreciated, along with other objects and features thereof, from the following detailed description taken in conjunction with the drawing.

### BRIEF DESCRIPTION OF THE DRAWINGS

FIGS. 1(a-c) illustrate one example of an electrical power generator of the present invention that is compatible with standard size AA conventional batteries;

FIG. 1(d) is a symbolic circuit diagram showing electrical connections for the electrical power generator shown in FIGS. 1(a-c);

FIG. 2 illustrates one example of an electrical power generator of the present invention that is compatible with standard size D conventional batteries;

FIGS. 3(a-d) are examples of electrical power generators of the present invention that use free moving magnets to convert motion into electrical energy;

FIGS. 4(a-d) are examples of friction cells of the present invention that use friction to convert motion into electrical energy;

FIGS. 5(a-e) demonstrates different methods to make methods of the present invention compatible with existing electrical appliances;

FIG. 6 shows an environment-friendly cost-efficient method to convert tidal energy into electrical energy;

FIGS. 7(a-h) illustrate the operation principles of field effect motion cells of the present invention;

FIGS. 8(a-f) show additional examples for field effect motion cells of the present invention; and

FIGS. 9(a-c) are examples for the applications of the present invention to collect wave energy.

### DETAILED DESCRIPTION OF THE INVENTION

The present invention describes methods to make electrical power generators that convert motion into electrical energy. In addition, these methods make the power generators user friendly by making them compatible with existing battery powered appliances. For simplicity, we will call such “motion-activated battery-compatible electrical power generating device” of the present invention a “motion cell” or “m-cell”. In most of the preferred embodiments, an m-cell of the present invention can replace a conventional battery to allow an existing battery-powered appliance to function normally with no or minimal modifications to the appliance. The word “compatible” in our definition does not always mean identical in every detailed specification. For example, the storage capacity of an m-cell is often less than the storage capacity of a conventional battery of the same size, but the life time of an m-cell is usually much longer than the life time of a conventional battery because of its capability to recharge itself. The output of an m-cell does not always need to be at constant voltage like most conventional batteries. An m-cell is “compatible” with a conventional battery in terms of its user-friendliness in replacing existing batteries while making battery powered appliances function normally, but it is not necessarily always able to replace batteries for all applications. For example, m-cell is especially useful for applications that require small bursts of energy such as remote controllers, flash lights, cellular phones, etc., but m-cell may be only helpful but not replaceable for other applications, especially those that require constant high power operations.

To facilitate clear understanding of the present invention, simplified symbolic views are used in the following figures. Objects are often not drawn to scale in order to show novel features clearly.

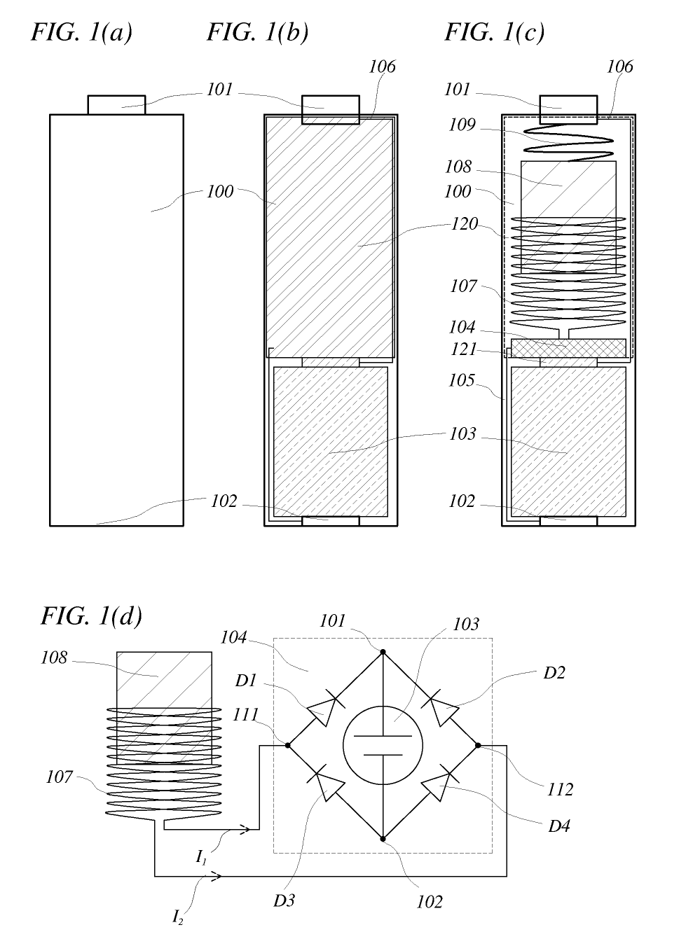

FIG. 1(a) shows the external view of one example of an m-cell (100) of the present invention that is similar in external dimension to a standard AA battery. This m-cell (100) has an anode (101) electrode and a cathode (102) electrode compatible with a standard AA battery. FIG. 1(b) is a cross-section diagram of the m-cell in FIG. 1(a), revealing that the m-cell comprises of a conventional rechargeable battery (103) and an electrical power generator (120). The size of the rechargeable battery (103) is smaller than a conventional AA battery in order to make room for the electrical power generator (120). Any well-known rechargeable battery, such as a Nickel Metal Hydride (Ni—MH) or Nickel Cadmium (NiCd) battery, can be used in this example. FIG. 1(c) is a cross-section diagram revealing one example of the electrical power generator (120) in FIG. 1(b) that comprises of a rectifier circuit (104), an electrical coil (107), and a magnet (108) that is attached to a spring coil (109). FIG. 1(d) is a symbolic circuit diagram illustrating the electrical connections of the components in the m-cell shown in FIG. 1(c). The rectifier circuit (104) is represented by a typical 4-diode (D1-D4) circuit configuration as shown in FIG. 1(d). The anode electrode (121) of the rechargeable battery (103) is connected to the anode electrode (101) of the m-cell (100) through an electrical connection (106), and to the rectifier circuit (104) as shown in FIG. 1(c) and FIG. 1(d). The cathode electrode of the rechargeable battery is connected to the cathode electrode of the m-cell (102), and to the rectifier circuit (104) through an electrical connection (105) as shown in FIG. 1(c) and FIG. 1(d). The electrical coil (107) is connected to the inputs of the rectifier circuit (104) as illustrated in FIG. 1(c) and FIG. 1(d). The magnet (108) is connected to the container of the m-cell through a spring coil (109) as illustrated in FIG. 1(c). In this configuration, external motion of the m-cell can cause the magnet (108) to vibrate up and down through the electrical coil (107). This motion induces changes in magnetic field in the coil that generates alternating electrical currents (I₁, I₂) as illustrated in FIG. 1(d). When the motion generated electrical current is in the direction of I₁, the current will flow through diode D1 and diode D4 to charge the rechargeable battery (103). When the motion generated electrical current is in the direction of I₂, the current will flow through diode D2 and diode D3 to charge the rechargeable battery (103). In other words, the rectifier circuit (104) redirects the generated currents (I₁, I₂) to the right polarity in order to charge the battery (103). This m-cell is fully compatible with conventional AA batteries while it is able to recharge itself by converting motion into electrical energy.

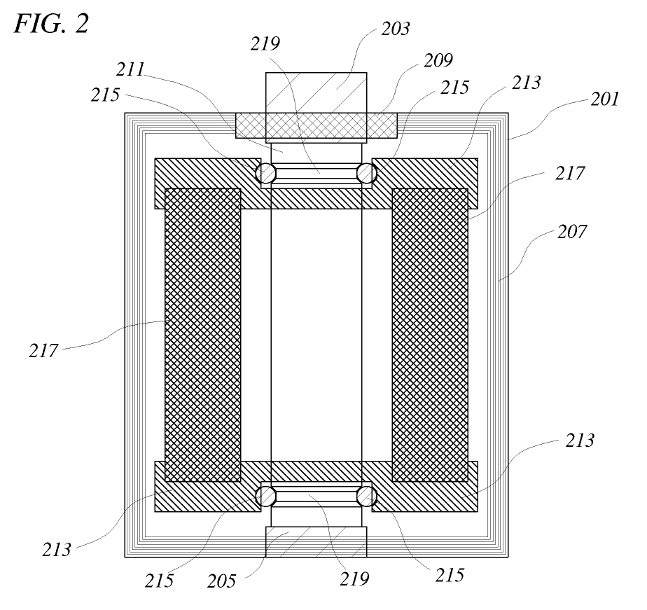

While specific embodiments of the invention have been illustrated and described herein, other modifications and changes will occur to those skilled in the art. For example, the shape of an m-cell does not have to meet the shape of a particular type of battery such as an AA battery; it can meet the shape of many kinds of existing batteries. The container of an m-cell also does not have to fit the space for one battery; it can fit into the space for two or more batteries, or the space for a fraction of a battery. In the above example, a typical 4-diode rectifier is used as one example of the rectifier circuit supporting an m-cell of the present invention. There are many other methods to implement rectifier circuits, ranging from mechanically controlled switches to highly sophisticated integrated circuits. Rectifiers are well known to those familiar with the art so there is no need to provide further details in our discussions. We also do not always need all the components shown in the above example. For certain applications such as a flash light, there is no need to use a rectifier in the m-cell. An m-cell also does not always need to work with an internal rechargeable battery. For example, we can replace the rechargeable battery with other types of storage devices such as capacitors. For many applications, we may not even need any storage devices in the m-cell. There are also many ways to implement electrical power generators for m-cells. In the above example, the vibrating motion of a magnet is converted into electrical energy. We can modify the configuration to allow an electrical coil to vibrate around a fixed magnet to achieve the same purpose. There are many other ways to build the power generator. A common way is to use a rotating magnet instead of vibrating magnet as illustrated by the example in FIG. 2.

FIG. 2 illustrates an example of an m-cell (201) that is compatible with size D batteries. A rechargeable battery is placed within the center axis (211) of the container. The anode electrode of the rechargeable battery is connected to the anode electrode (203) of the m-cell and a rectifier circuit (209). The cathode electrode of the rechargeable battery is connected to the cathode electrode (205) of the m-cell and the rectifier circuit (209). The rectifier circuit (209) is also connected to electrical coils (207) surrounding the walls of the m-cell container. Two magnets (217) are placed on rotational frames (213). Rolling balls (215) moving within rotational channels (219) on the center axis (211) allow the rotational frames (213) to rotate around the center axis (211) with small friction. It is desirable to use two magnets (217) of different weight so that external motion of the m-cell will cause the magnets (217) to rotate around the center axis (211). The change in magnetic field induced by the rotational motions generates electrical currents that are redirected by the rectifier circuit (209) to charge the rechargeable battery based on similar principles as those used in the m-cell in FIGS. 1(a-d). This m-cell is therefore fully compatible with conventional size D batteries while it is also able to recharge itself by converting motion into electrical energy.

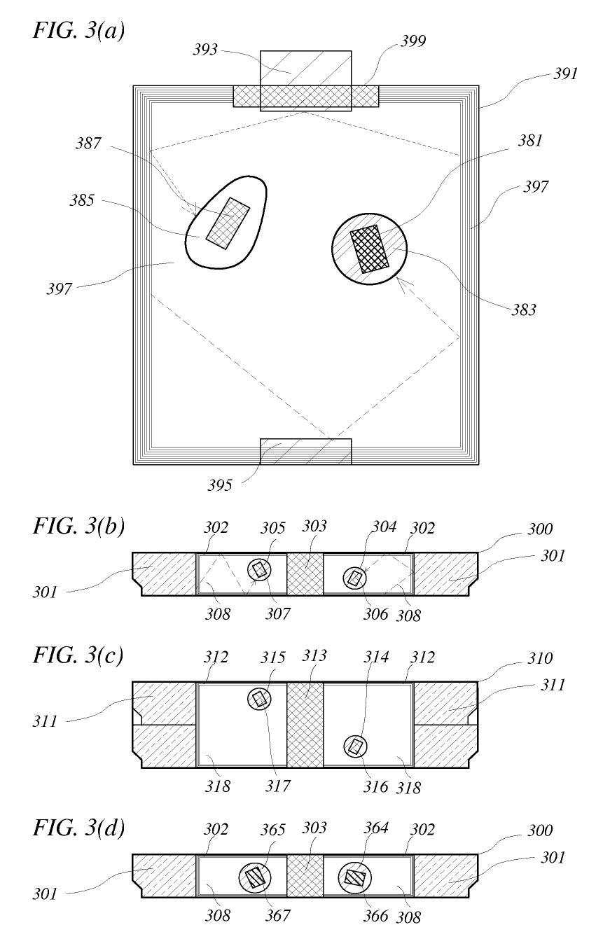

For the examples in FIGS. 1-2, external motion of an m-cell is converted into one dimensional motion (back and forth motion in FIG. 1 and rotation along one axis in FIG. 2) of magnets relative to electrical coils in order to convert motion into electrical energy. FIG. 3(a) shows an example of an electrical power generator of the present invention that is able to convert multiple dimensional motions into electrical energy. Similar to the example in FIG. 2, the m-cell (391) in FIG. 3(a) has a container, an anode electrode (393), and a cathode electrode (395) making it compatible with conventional batteries. A rechargeable battery may be placed inside but it is not shown for simplicity. Similar to the m-cell in FIG. 2, this m-cell (391) is also surrounded by electrical coils (397) that are connected to a rectifier circuit (399). These configurations allow the m-cell (391) to generate electrical energy as soon as there is a changing magnetic field within the electrical coils (397). In this example, the changing magnetic field is provided by a free moving magnet (381) in a bouncing ball (383). There are many ways to build this bouncing ball (383); one example is to coat a magnet (381) with elastic materials like rubber. External motion of the m-cell (391) can cause the bouncing ball (383) to bounce around and to rotate within the electrical coils (397) causing changes in magnetic fields that generate electrical currents. The three dimensional motions plus rotational motions of the bouncing ball (383) all can generate electrical energy. The bouncing ball also does not have to be a sphere. An irregular shape is actually preferable because it can cause rapidly changing magnetic fields. FIG. 3(a) also shows another example of a free-moving object (385) that has a magnet (387) coated by irregularly shaped elastic materials. Although two bouncing objects (383, 385) are shown in FIG. 3(a) for convenience in drawing, it is usually undesirable to have two such bouncing objects within one container because they will tend to cancel the power generating effects of each other.

Manufacture procedures for the bouncing magnets (383, 385) can be extremely simple and inexpensive. Such simplicity in manufacture provides the flexibility to make free-moving magnets in very small sizes, allowing the possibility to build small size m-cells. FIG. 3(b) shows an example of an m-cell (300) of the present invention that is made compatible with a typical button cell or coin cell battery. Coin cells are typically used in car keys with a thickness of around one millimeter (mm) and a diameter of around 15 mm. Button cells are typically used in electrical watches and cameras with a thickness of around 5 mm and a diameter of less than 10 mm. It is nearly impossible to put prior art electrical power generators into such small dimensions. The m-cell shown in FIG. 3(b) is compatible in size with a typical coil cell. The inner space of the m-cell comprises of one or more chambers (308). Each chamber (308) comprises of electrical coils (302) and space for small free-moving magnet(s) (304, 305) of the present invention. It is typically desirable to place a rechargeable battery (301) and rectifier circuit (303) in the m-cell as illustrated in FIG. 3(b). External motions of the m-cell (300) can cause the bouncing magnets (304, 305) to bounce around and to rotate relative to the electrical coils (302) in the chambers (308). The magnets (306, 307) in the free-moving objects (304, 305) create changes in magnetic field to charge the rechargeable battery (301) through the rectifier circuit (303) in similar ways as in previous examples.

Although the m-cell of the present invention can function in a very small space, it is still desirable to have more space for simpler manufacture procedures. FIG. 3(c) shows an example of an m-cell (310) that is made compatible to fit into the space of two stacked coin cells. In this way, one can double the volume of the bouncing chambers (318) and have space for more electrical coils (312). The magnets (316, 317) in the bouncing balls (314, 315) can have more space than in the previous example. This m-cell (310) also can have rechargeable batteries (311) and rectifier circuits (313) similar to previous examples. Most car keys use two stacked coin cells instead of one coin cell. We can replace two stacked coin cells with one m-cell shown in FIG. 3(c) or two m-cells shown in FIG. 3(b).

The m-cells of the present invention are extremely user friendly. For example, we can use m-cells to replace the batteries in a television remote controller without making any changes to the TV remote controller. Whenever the m-cell is running low in charge, a few shakes of the remote controller will charge it enough to support further operations. We also can use m-cells to replace the batteries in a garage door remote controller. When a garage door controller is placed in a car, the natural vibrations and accelerations of the car can keep the m-cells charged. The garage door remote controller will not run out of batteries any more. When a properly designed m-cell is used in a cellular phone, the natural motion of the user is usually enough to keep the m-cell charged—significantly reducing the inconvenience of recharging cellular phone batteries. The present invention certainly can support most battery powered toys.

While specific embodiments of the invention have been illustrated and described herein, it is realized that other modifications and changes will occur to those skilled in the art. The scope of the present invention should not be limited by above specific examples. For example, there are many ways to implement electrical coils for generating electrical power from changing magnetic fields. Detailed designs of those electrical coils are therefore not shown in the above discussions. The m-cells of the present invention can be compatible with all kinds of conventional batteries including, but not limited to, sizes AAA, AA, A, B, C, D, coin cells, button cells, rectangle cells, cellular phone cells, laptop computer batteries, etc. In our examples, the bouncing magnets are coated with elastic materials in order to preserve kinetic energy. In many cases, there is no need to coat the magnets with elastic materials. Free-moving magnets of any shape are applicable. The motions of magnets do not have to be bouncing; other kinds of free motions such as rolling or tumbling also work well. For example, the m-cell shown in FIG. 3(d) is nearly identical to the m-cell shown in FIG. 3(b) except that the bouncing balls (304, 305) are replaced with rolling cylinders (364, 365) that comprise of magnets (366, 367). The rolling motion of the cylinders (364, 365) can cause the magnets (366, 367) to change magnetic fields to generate electric energy.

A free-moving magnet used in the present invention is defined as a magnet that does not have bondage such as rotation frames or spring coils to constrain its motion to one-dimensional motion. Conventional magnetic power generators always confine the motion of magnets relative to electrical coil using rotational frames or vibration spring coils. The magnets or coils are always bounded for linear motion or rotational motion. Such constraints limit the freedom to convert different types of motion into electrical power. The need to provide moving parts such as rotational frames or vibrating frames also makes it more complicated to manufacture. The free moving magnets in the above examples are allowed to move freely in a given container without bondage from frames or springs. The manufacture procedures for such free moving magnetic are simplified, and more freedom in converting different types of motion into electrical energy is attained. Due to simplicity, the free-moving magnet cells are extremely easy to manufacture compared to other types of magnetic power generators. The major disadvantage is its irregular power output due to irregular changes in magnetic fields. The rectifier circuits supporting free-moving magnet cells may need to be more complex than conventional rectifier circuits. Fortunately, current art integrated circuit technologies allow design of highly sophisticated rectifying circuits that can be optimized for such applications. Another method to regulate the output of the free-moving magnet cells is to simplify the motions of the magnets; one example is to allow only rolling motions along one direction.

While specific embodiments of the invention have been illustrated and described herein, it is realized that other modifications and changes will occur to those skilled in the art. The scope of the present invention should not be limited by above specific examples. For the above examples, magnetic mechanisms are utilized as the electrical power generating mechanism. Other mechanisms are also applicable for m-cells of the present invention.

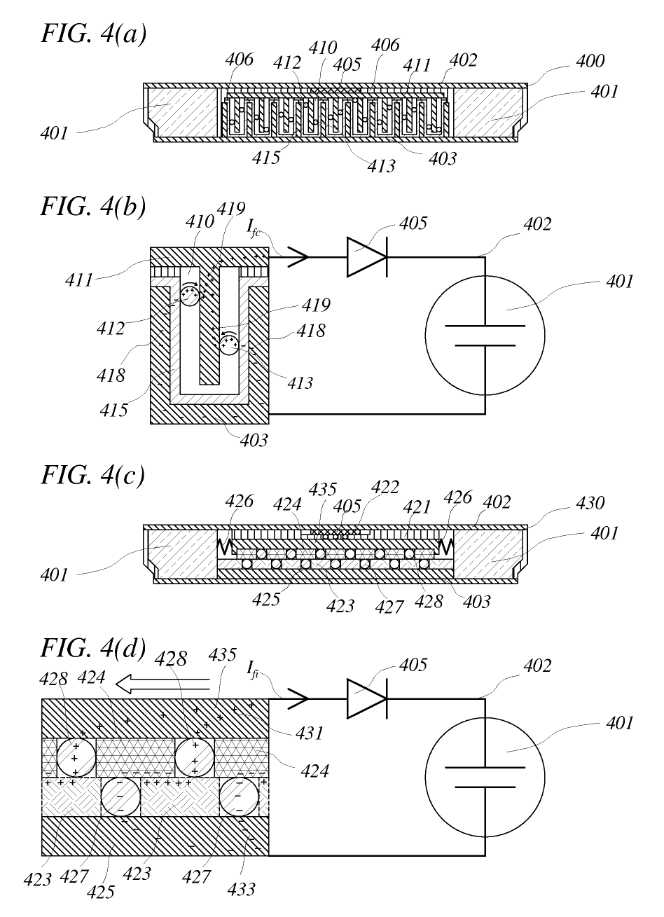

FIG. 4(a) shows an example of an m-cell (400) of the present invention that is similar in external shape to the example shown in FIG. 3(b). It also can have rechargeable batteries (401) that can be placed in similar ways. The anode electrode of the rechargeable battery is connected to the anode electrode (402) of the m-cell (400). The cathode electrode of the rechargeable battery is connected to the cathode electrode (403) of the m-cell (400). There are a plurality of “friction cells” (410) packed inside the m-cell (400). A magnified cross section view for one of the friction cells (410) is shown in FIG. 4(b). FIG. 4(b) also shows symbolic circuit connections of the m-cell in FIG. 4(a). A friction cell of the present invention generates electric energy from friction between different materials. For this example, the friction cell comprises of a cathode electrode that is also connected to the cathode electrode (403) of the m-cell (400). The cathode electrode of the friction cell is covered by a layer of friction coating (415) as illustrated in FIG. 4(a) and FIG. 4(b). The anode electrode (411) of the friction cell is connected to a rectifier circuit (405) as shown in FIG. 4(a). The rectifier circuit (405) is represented by a single diode in FIG. 4(b) but there are many methods to implement this rectifier circuit. Inside the friction cell (400), there are rolling cylinders (412, 413) that roll between the friction cell anode electrode (411) and the friction coating (415) on the cathode electrode (403). For this example, we assume that the friction coating (415) is made of materials that have high electron affinity such as conductive plastic materials, and the rolling cylinders (412, 413) are made of conductive materials that have low electron affinity such as heavy metal. The friction generated by the rolling motion of those rolling cylinders (412, 413) can cause the rolling cylinders (412, 413) to carry positive charges (419) that are represented by (+) signs in FIG. 4(b). In the mean time, the friction will generate negative charges (418) on the friction coating (415). The negative charges (418) are represented by (−) signs in FIG. 4(b). Due to voltage differences, the positive charges (419) will flow to the anode electrode (411) of the friction cell (410), and the negative charges (418) generated by friction will flow to the cathode electrode (403). The charge flows creates an electrical current (I_{fc}) that can charge the rechargeable battery (401). In such ways, the external motions of the m-cell (400) can cause friction between the rolling cylinders (412, 413) in the friction cells (410) to generate electrical energy.

While specific embodiments of the invention have been illustrated and described herein, it is realized that other modifications and changes will occur to those skilled in the art. The scope of the present invention should not be limited by above specific examples. Friction cells of the present invention can be implemented in many ways. FIG. 4(c) shows another example that has a similar structure to that in FIG. 4(a) except that its friction cell comprises of two friction planes (425, 435). The bottom friction plane (425) is a fixed conductive plate connected to the cathode electrode (403) of the m-cell (430). There are friction coating (423) materials attached to this bottom friction plane (425), and conductor rolling cylinders (427) placed between the friction coating (423) as illustrated by the magnified cross section drawing in FIG. 4(d). FIG. 4(d) also shows the symbolic circuit connections for the m-cell (430) in FIG. 4(c). The top friction plane (435) is a movable conductor plate attached to spring coils (426) as illustrated in FIG. 4(c). There are friction coating (424) materials attached to this top friction plane (435), and conductor rolling cylinders (428) placed between the friction coating (424) as illustrated by FIG. 4(d). This top friction plane (435) is also the anode electrode of the friction cell that is connected to a rectifier circuit (405) through conductor rolling cylinders (422) as illustrated in FIG. 4(c). External motion of the m-cell (430) can cause the top friction plane (435) to vibrate relative to the bottom friction plane (425). The two kinds of friction coating (423, 424) attached to the two friction planes (425, 435) generate electrical charges (431, 433) while rubbing against each other. In this example, we assume the bottom friction coating (423) generates positive charges (431) while the top friction coating (424) generates negative charges (433). When the bottom friction coating (423) touches the top rolling cylinders (428), positive charges (431) will flow toward the anode plane (435). When the top friction coating (424) touches the bottom rolling cylinders (427), negative charges (433) will flow toward the cathode plane (425). The charge flow generates an electrical current (I_{fi}) that can charge the rechargeable battery (401). In such ways, the external motions of the m-cell (430) can generate electrical energy.

Friction was the earliest method to generate electricity in the earliest days of scientific studies of electricity, but magnetism became the dominating mechanism for electrical power generators. There is lot of room for improvement to find better materials and to have better designs in friction cells of the present invention. Unlike magnetic power generators, friction cells do not require heavy materials such as magnets and electrical coils so that they have more flexibility in supporting applications of the present invention. Friction cells can be built from low cost materials or even bio-degradable materials. There is better flexibility to arrange friction cells into different shapes. Upon disclosure of the present invention, a wide variety of friction cells are expected to be developed.

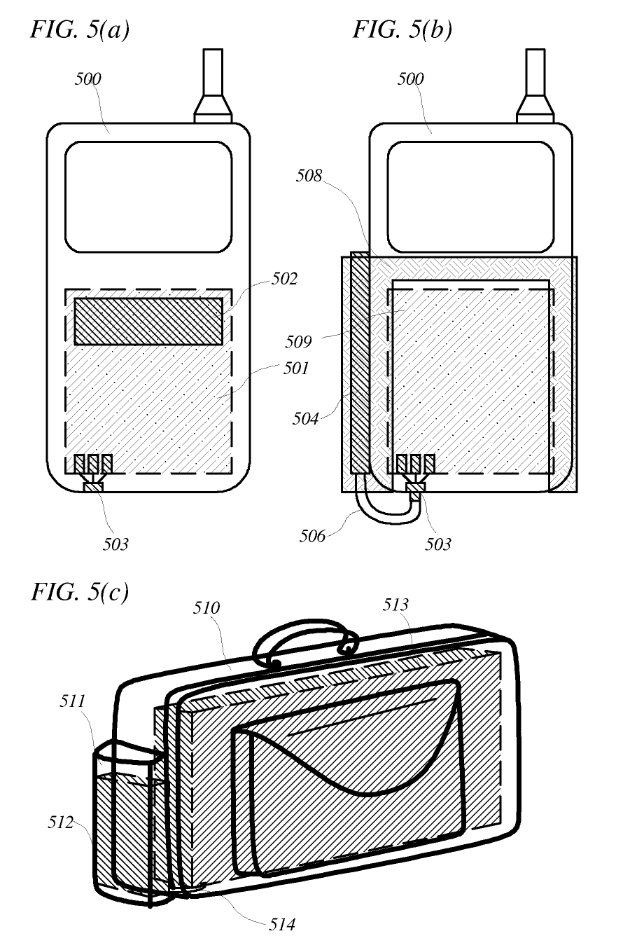

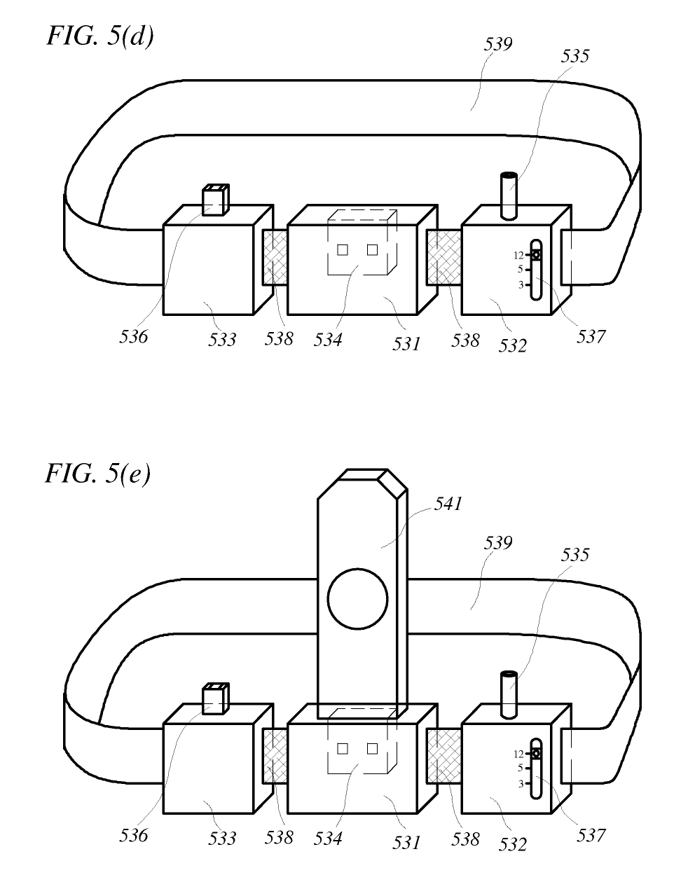

While specific embodiments of the invention have been illustrated and described herein, it is realized that other modifications and changes will occur to those skilled in the art. The scope of the present invention should not be limited by above specific examples. In the above examples, electrical power generators are placed in battery-shaped containers to make them compatible with existing batteries. That is not the only way to make electrical power generators compatible with existing battery-powered appliances. FIG. 5(a) shows a symbolic view for one example when a cellular phone (500) is equipped with a rechargeable battery (501). We can place an m-cell (502) of the present invention to occupy part of the space inside the battery (501) as a method to make m-cell compatible with a cellular phone (500). However, that is not the only method. Cellular phones are often placed in a protective coat (508). The battery (501, 509) used by cellular phones always has input socket (503) for chargers. We can place an m-cell (504) of the present invention attached to the protection coat as illustrated in FIG. 5(b), and connect the power output of the m-cell to the cellular phone battery (509) through existing input socket (503). In this way, we do not need to make any changes to existing cellular phones (500) and do not need to make any changes to existing cellular phone batteries (509), while we enjoy the convenience provided by m-cells (504) by attaching the m-cell to the cellular phone protection coat (508). Similar designs are applicable to other types of portable devices such as video recorders, digital cameras, black berry, audio recorders, radios, audio headsets, microphones, or laptop computers. For example, an m-cell (512) can be placed inside a side pocket (511) of a typical bag (510) used to carry a lap-top computer (513) as illustrated in FIG. 5(c). The power output of the m-cell (514) is plugged into the charger input of the laptop computer while the user carries the computer in the bag. When the bag (510) is carried or when it is placed in a vehicle, the natural motions of the bag (510) are constantly converted into electrical energy by m-cell (512) to keep the battery charged to help reduce the needs to recharge the battery. In the mean time, there is no need to make any changes to the laptop computer as well as its battery. The same bag also can be used to carry and to charge other types of portable appliances such as video recorders.

FIG. 5(d) shows a device comprising a plurality of m-cells (531-533) attached to a flexible belt (539). The flexible belt (539) allows this device to be attached to user's wrist, ankle, forehead, or other body parts. The attached m-cells (531-533) convert motion into electrical energy. The m-cells may have storage devices (not shown) to store generated electrical energy. The outputs (534-536) of these m-cells (531-533) are designed to be compatible with existing portable devices. For example, the power output of one m-cell (531) is shaped to accept Universal Serial Bus (USB) interface (534). Portable devices charged through USB interface, such as iPOD or MP3 music players, can be charged using this interface (534). The power output (535) of the second m-cell (532) is shaped to accept portable computers or cellular phones. In this example, the m-cell (532) is equipped with a switch (537) used to select the voltage of power output. The power output (536) of another m-cell (533) is shaped to accept digital cameras. These m-cells (531-533) can be connected electrically using flexible connections (538) to share generated power. It is desirable to have the flexibility to attach or detach m-cells to the same belt (539). Not every m-cell has to have its own power output; we can have m-cells that are used only to generate electrical power. FIG. 5(e) illustrates the situation when an iPOD (541) is charged by the device in FIG. 5(d). Similar designs are applicable to other types of portable devices such as video recorders, digital cameras, black berry, audio recorders, radios, audio headsets, microphones, or laptop computers.

While specific embodiments of the invention have been illustrated and described herein, it is realized that other modifications and changes will occur to those skilled in the art. The scope of the present invention should not be limited by above specific examples. The key features for the examples shown in FIGS. 5(a-e) are detachable power outputs of m-cells that are compatible with the battery charger inputs of existing portable devices. Such compatible power outputs allow m-cells to provide electrical energy to existing portable appliances with no or minimal modifications to the portable appliances. The detachable power outputs also allow the users to use the same m-cells to support different appliances. These key features allow m-cells of the present invention to be extremely convenient to users.

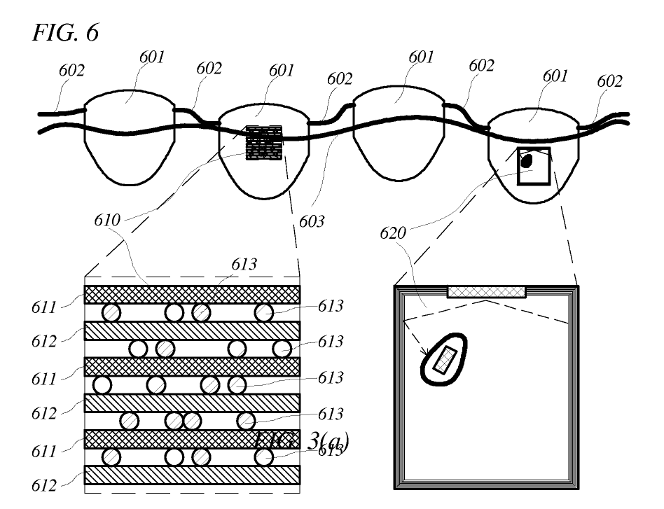

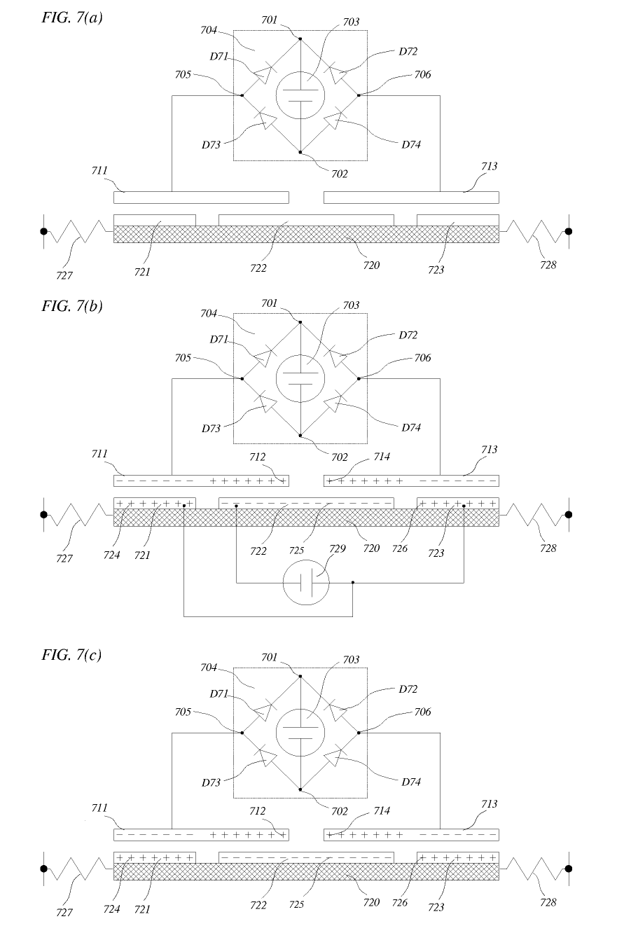

Besides providing additional conveniences for battery powered appliances, another primary objective of the present invention is to make energy generators more environment-friendly. By reducing the need to replace batteries, the present invention already can help reduce pollution. In addition, all the components for m-cells of the present invention can be manufactured without dangerous chemicals. The friction cells actually can be manufactured with bio-degradable natural materials at very low cost. Therefore, the present invention can provide environment-friendly methods to generate electrical power. FIG. 6 is a symbolic diagram showing a plurality of m-cells placed into buoys (601) that are placed on water (603) and linked by cables (602). The cables (602) contain electrical wires to transfer generated electrical energy to energy storage devices. The buoys (601) can be decorated as natural objects such as coconuts to make their look also environment-friendly. Any one of the m-cells of the present invention can be used for such applications. For example, we can use a friction cell (610) as shown by the magnified cross section diagram in FIG. 6. In this example, the friction cell (610) comprises of rolling balls (613) rolling between cathode plates and anode plates (611, 612). The water waves will cause those rolling balls to move around causing friction to separate positive and negative charges. Those separated charges are collected by the conductive cathode plates and anode plates to generate electrical power. FIG. 6 shows another example that uses a bouncing magnet cell (620) similar to the one in FIG. (2). Such power generators of the present invention are simple in structure so that electrical energy can be collected at very low cost. Those cells can be built completely from environment-friendly materials so that they won't cause any environment problems even when they are destroyed by accidents. We prefer not to place rechargeable batteries in the buoys to avoid chemical materials for environment considerations, but it is also possible to place rechargeable batteries in the buoys for easiness in collection of produced energy. An energy storage device can be placed on shore to store the energy generated by those m-cells. In such method, tidal energy can be converted into electrical power using cost efficient and environment-friendly methods. M-cells of the present invention also can be placed in vehicles such as boats or cars, and the natural motion of the vehicles will create clean, cost efficient energy.

While specific embodiments of the invention have been illustrated and described herein, it is realized that other modifications and changes will occur to those skilled in the art. The scope of the present invention should not be limited by above specific examples. For example, instead of using magnetic components to generate electrical power, we can use field effect motion cells of the present invention to convert motion into electrical energy.

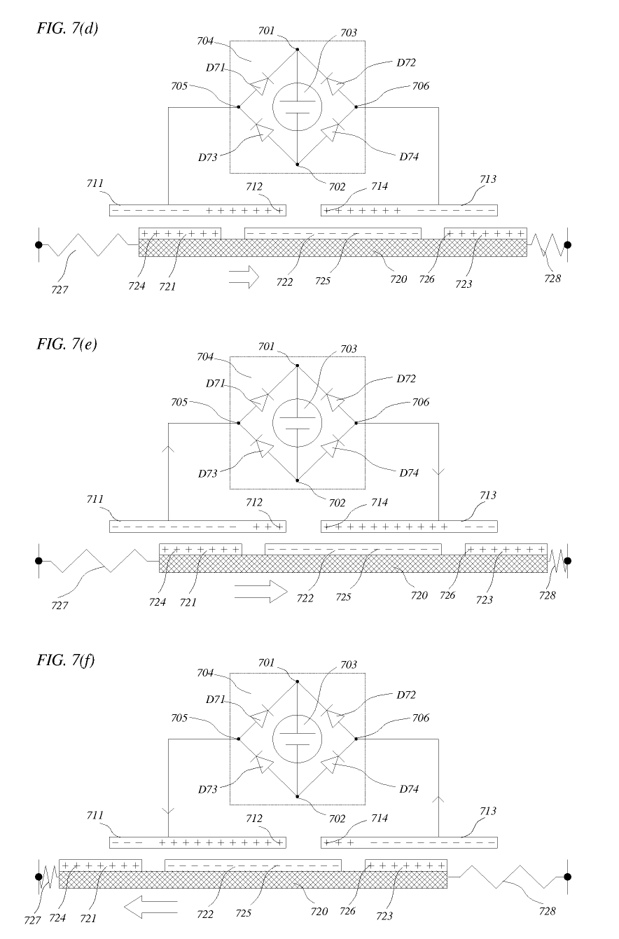

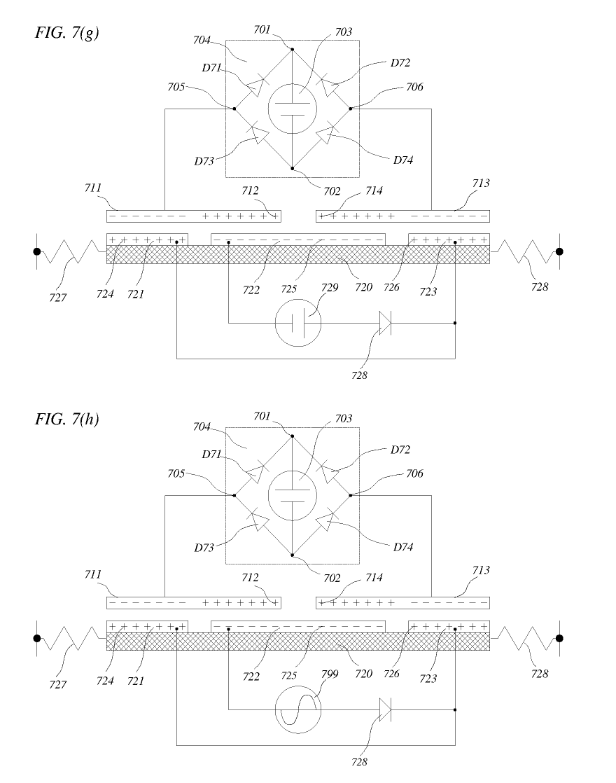

FIG. 7(a) is a simplified symbolic diagram illustrating the basic structures for one example of a field effect motion cell of the present invention. In this example, a rechargeable battery (703) is connected to two output terminals (701, 702) of a rectifier (704) that comprises 4 diodes (D71-D74). The input terminals (705, 706) of the rectifier (704) are connected to two plates (711, 713) called “collector terminals”. These collector terminals (711, 713) are placed closely to three plates (721, 722, 723) called “field terminals”. These field terminals (721, 722, 723) are mounted on a movable carrier (720) that is held between two springs (727, 728) as illustrated in FIG. 7(a). To generate electrical fields, we need to introduce electrical charges to the field terminals (721, 722, 723). There are many ways to charge the field terminals. For example, we can implant electrical charges into insulators or electrically isolated materials and use the charged materials as field terminals. The other way is to apply voltages to the isolated terminals. For example, we can connect the negative electrode of a battery (729) to the center field terminal (722), while connect the positive terminal of the battery to the other two field terminals (721, 723) as illustrated in FIG. 7(b). Typically, the voltage used to charge the field terminals is much higher than the voltage of the rechargeable battery (703). Under the configuration in FIG. 7(b), the electrical field introduced by the applied voltage will introduce negative charges (725) in the center plate (722), positive charges (724, 726) on the other two plates (721, 723), and charges (712, 714) of opposite signs would be induced on the collector terminals (711, 713) as shown in FIG. 7(b). To operate the motion cell, we can keep the charging voltage source (729) connected as shown in FIG. 7(b), we also can disconnect the charging circuit as shown in FIG. 7(c). As shown in FIG. 7(c), the field terminals (721, 722, 723) are electrically isolated so the charges (724, 725, 726) on the field terminals are trapped even if we remove the battery (729). The electrical fields generated by those trapped charges hold the charges (712, 714) on the collector terminals (711, 713) at steady state as illustrated in FIG. 7(c). At steady state, the electrical force between electrical charges will try to hold the movable carrier (720) at the same location. If a force moves the movable carrier away from the steady state location as illustrated in FIG. 7(d), the repelling force between the electrical charges will establish a voltage called the “field induced voltage” across the collector terminals. If the field induced voltage is lower than the voltage of the rechargeable battery (Vr) plus two diode voltage (Vdi), all the diodes (D71 -D74) will remain off, no current (except small leakage current) is allowed to flow through the rectifier (704), and the repelling electrical force would try to push the movable carrier (720) back to steady state location. If the motion of the movable carrier is large enough so that the field induced voltage is high enough to turn on the rectifier and allow a current flow from the collector terminal (711) on the left side through D71, rechargeable battery (703), D74, to the other collector terminal (713); the electrical charges on the collector terminals (711, 713) would be redistributed as illustrated in FIG. 7(e), and a new steady state would be established; the motion energy is converted into electrical energy stored in the rechargeable battery (703). Similarly, if a large enough force is applied on the movable carrier (720) to the other direction so that field induced voltage is high enough to generate a current flow from the collector terminal (713) on the right side through D72, rechargeable battery (703), D73, to the other collector terminal (711), the electrical charges on the collector terminals (711, 713) would be redistributed as illustrated in FIG. 7(f); a new steady state would be established, and the motion energy is converted into electrical energy stored in the rechargeable battery (703).

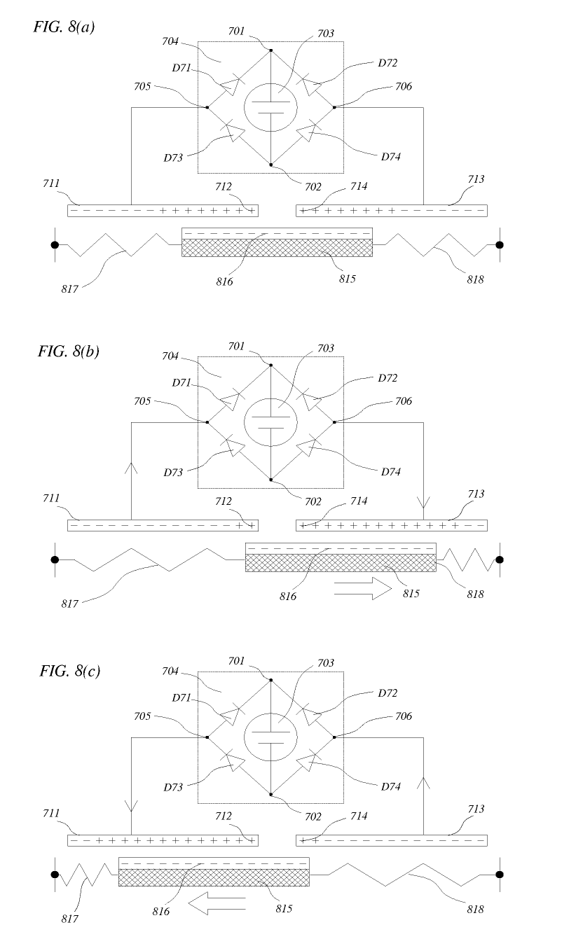

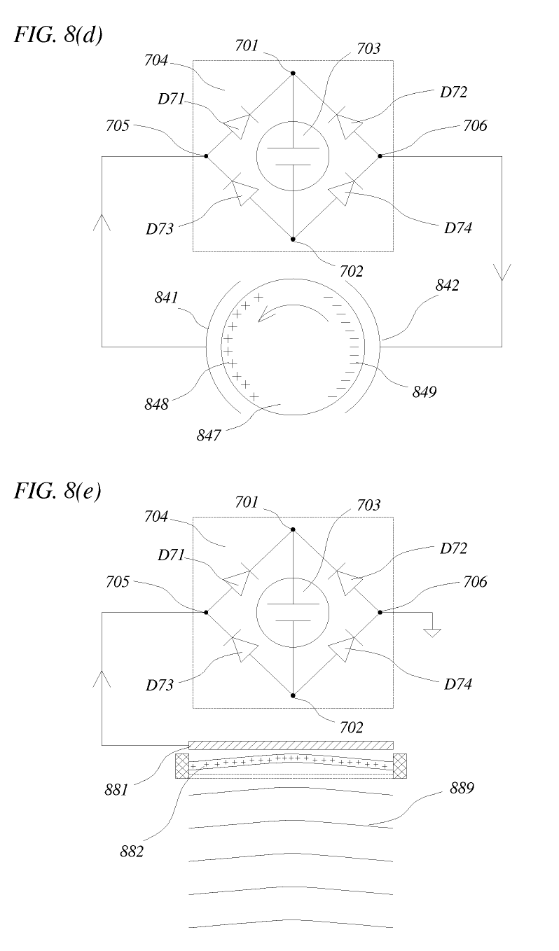

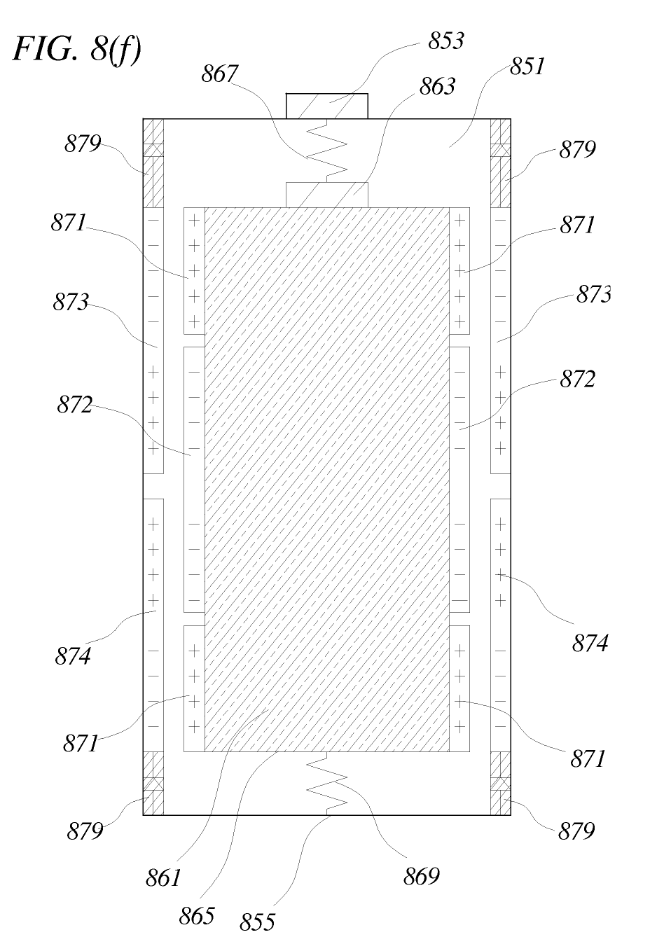

While specific embodiments of the invention have been illustrated and described herein, it is realized that other modifications and changes will occur to those skilled in the art. The scope of the present invention should not be limited by the above specific examples. For example, a typical 4-diode rectifier is used in the above example shown in FIGS. 7(a-f) while wide varieties of circuits are applicable to serve our purpose. The energy storage device in the above example is a rechargeable battery while we can use other types of energy storage device such as a capacitor, flying wheels, or heated water. In our figures, distributions of electrical charges are illustrated by simplified drawings while the actual detailed distributions are more complex. The movable carrier is held by springs (727, 728) which are helpful in storing part of the motion energies, but we certainly do not have to use springs. The key feature for field effect motion cells of the present invention is the mechanism that generates electrical power using the relative motion between field terminal(s) and collector terminal(s). A “field terminal” defined in the present invention is a structure that holds electrical charges to generate electrical fields. Field terminals can be manufactured by many kinds of materials (conductors, semiconductors, or insulators) in different shapes while distributed in different configurations. A “collector terminal” defined in the present invention is a structure that reacts to the electrical fields of the field terminal(s) to generate electrical power from the relative motion between collector terminal(s) and field terminal(s). In the above example the field terminals are placed on a movable carrier while it is equally applicable to place collector terminals on movable carrier(s). We certainly can place both types of terminals on movable carriers. The above example has two collector terminals while we can have more collector terminals connected serially or in parallel. We also can have only one collector terminal. The collector terminals do not have to be plates, they can be shaped in many ways. There are many ways to charge the field terminals. In the above example shown in FIGS. 7(a-f) the field terminals are charged by applying a voltage on conductor plates then remove the voltage source. It is well known that materials with build-in charge can be manufactured by implanting charges into insulators or electrically isolated materials. Other methods, such as charging with high voltage then removing the voltage source, also exist. It should be obvious that we do not have to remove the voltage source shown in FIG. 7(b); as soon as the voltage of the charging battery (729) is higher than (Vr+2Vdi), electrical current would only flow into the rechargeable battery (703), instead of the charging battery (729). We certainly can add one diode (728) as shown in FIG. 7(g) to make sure we do not have reversed charge flow on the field terminals. The charging power source also does not have to be a battery, an AC power source (799) and a diode (728) as shown in FIG. 7(h) will work fine. A person with ordinary skill in the art certainly can develop wide varieties of designs for field effect motion cells of the present invention. FIGS. 8(a-e) show more examples.

FIG. 8(a) shows another example of a field effect motion cell of the present invention. The collector terminals, rechargeable battery, and rectifier used in this example are identical to the example shown in FIGS. 7(a-h), while the field terminal in FIG. 8(a) comprises only one terminal (816) charged with one type of charge. This field terminal is placed on a movable carrier (815) between two springs (817, 818). When the movable carrier (815) is pushed far enough to the right hand side, as shown in FIG. 8(b), an electrical current flow from the collector terminal (711) on the left side through D71, rechargeable battery (703), D74, to the other collector terminal (713); the electrical charges on the collector terminals (711, 713) would be redistributed as illustrated in FIG. 8(b), and a new steady state would be established; the motion energy is converted into electrical energy stored in the rechargeable battery (703). When the movable carrier (815) is pushed to the left hand side, as shown in FIG. 8(c), an electrical current flow from the collector terminal (713) on the right side through D72, rechargeable battery (703), D73, to the other collector terminal (711); the electrical charges on the collector terminals (711, 713) would be redistributed as illustrated in FIG. 8(c), and a new steady state would be established; the motion energy is converted into electrical energy stored in the rechargeable battery (703). The example shown in FIGS. 8(a-c) is less efficient than the example shown in FIGS. 7(a-f) while the motion cell is easier to build.

FIG. 8(d) shows an example when the field terminal (847) is a cylinder charged with isolated electrical charges (848, 849). When this field terminal (847) is rotated relative to collector terminals (841, 842), the rotational motion generates electrical power in similar principles.

FIG. 8(e) shows an example that has only one collector terminal (705). The other input of the rectifier (706) is connected to ground voltage. In this example a charged vibration plate (882) is used as a field terminal. This vibration plate (882) deforms when there is change in surface pressure, which may be caused by incoming sound waves (889) or changes in air or fluid pressures. When this field terminal (882) is deformed to be closer or farther from the collector terminal (881), electrical field induced current can go through the rectifier (704) to charge the rechargeable battery (703). The structures of this field effect motion cell in FIG. 8(e) are similar to the structures of microphones. Microphones convert sound energy into electrical signals as sensors to determine the amplitude of sound waves. The present invention provides electrical generators to collect motion energies to provide electrical energy sources. Although motion cells of the present invention also can be used to collect sound energy, the purposes and functions are completely different. Devices based on the principles shown in FIG. 8(e) also can be designed to be effective sound energy absorbers. We can place them along a highway to reduce noise while collecting useful energy.

The field effect motion cells of the present invention have many advantages over magnetic motion cells. Field effect motion cells provide more flexibility to build motion cells in terms of choice in materials, shapes, and structures. It is much easier to shield electrical fields than magnetic fields from influencing other circuits. Field effect motion cells are also typically lighter than magnetic motion cells.

One major objective of the present invention is to provide convenient electrical power generators by fitting the power generator into containers that are compatible with existing batteries. FIG. 8(f) shows an example when a field effect motion cell (851) is shaped to be compatible with existing batteries. A rechargeable battery (861) serves the functions of energy storage device as well as the field terminal carrier. The positive electrode (863) of the rechargeable battery is connected to the positive electrode (853) of the motion cell through a metal spring (867). The negative electrode (865) of the rechargeable battery is connected to the negative electrode (855) of the motion cell through another metal spring (869). These springs (867, 869) are electrical conductors and provide mechanical support. They also act as energy storage devices to store part of the motion energy. Charged field terminals (871, 872), are placed on the surface of the rechargeable battery (861) while collector terminals (873, 874) are placed on the inside walls as shown in FIG. 8(e). Diodes (879) are also placed inside the motion cell to form rectifying circuits; the connections of diodes are not shown in FIG. 8(e). Based on similar principles described in previous examples, motion of this battery shaped field effect motion cell (851) can be converted to electrical power charging the rechargeable battery (861).

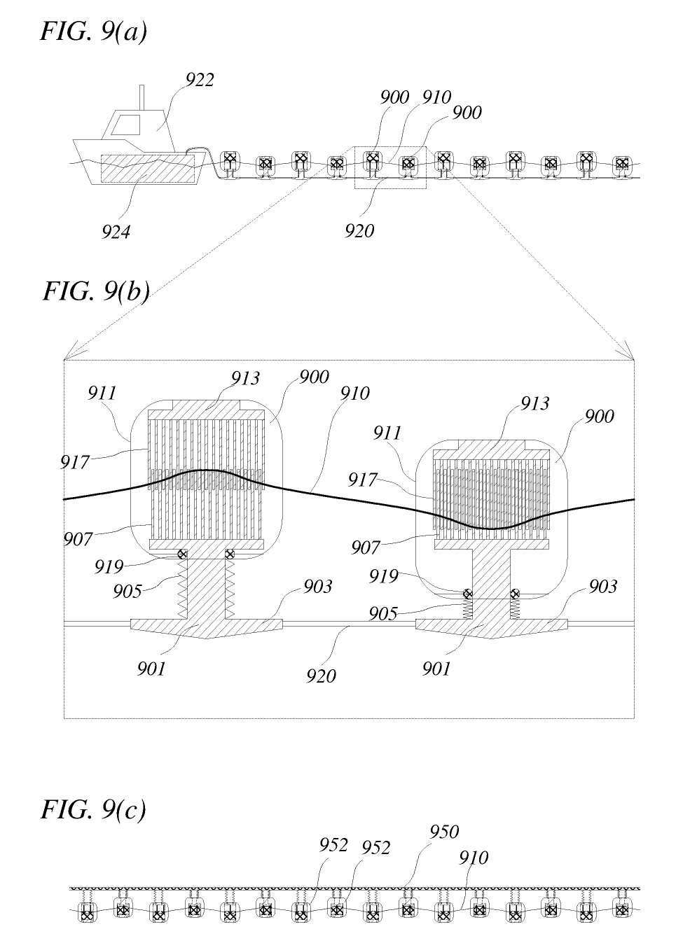

Another major objective of the present invention is to provide environmentally friendly energy collectors. In FIG. 6 we showed motion cells placed inside buoys to convert wave energy into electrical energy. FIGS. 9(a-c) provide additional examples. FIG. 9(a) shows an example that uses many buoys (900) linked by an underwater cable (920). The water waves (910) cause motion of the buoys (900) that convert motion into electrical power to store into a rechargeable battery (924) on a boat (922). We can use any kind of motion cells for this application. FIG. 9(b) is a magnified diagram illustrating an example when field effect motion cells are used for this application. Each buoy (900) comprises a floating container (911), and a fixture (901) linked by springs (905). The floating container (911) moves relatively easily with water waves (910). The fixture (901) is placed under water so that waves (901) affect it less. It also has a side wing (903) that provides counter force against wave motion. The fixtures (901) of different buoys (900) are linked by cables (920) that provide an electrical connection as well as mechanical support for further stability. Therefore the fixtures (901) are relatively stable against wave motion while the floating containers (911) can move with waves relatively easily. We can use the relative motion between the fixtures (901) and the floating containers (911) to generate electrical power using motion cells. For the example shown in FIG. 9(b), the buoy comprises a field effect motion cell (913) that has a plurality of field terminals (917) connected to the floating container (911), and a plurality of collector terminals (907) connected to the fixture (901). The relative motion between the floating container (911) and the fixture (901) cause relative motion between the collector terminals and the field terminals (907, 917) to convert wave energy into electrical power. FIG. 9(c) illustrates an alternative design when a fixture platform (950) is placed above water instead of under water. Since the fixture platform (950) links many buoys (952), the force of water wave (910) is averaged out so that it is relatively more stable than individual buoy. The relative motions between buoys (952) and the fixture platform (950) are therefore convertible into electrical power by motion cells. It is also possible to use the relative motion between different buoys to generate energy. The motion cells, as well as energy storage devices, can be placed inside the buoys or placed on the platform. Using such motion cells, there is no need to build dams to collect energy from water. It is also obvious that similar structures can be placed into vehicles (cars, boats, air planes) to stabilize vehicles while collecting energy at the same time.

The m-cells of the present invention may not be the most efficient ways to collect energy because we emphasize convenience and cost efficiency rather than energy conversion efficiency. Existing clean energy collectors such as solar cells or wind mills are all excellent methods but they can not compete with oil in price. It will take huge investments, including changes in infrastructures in order to reduce reliance on oil for human societies. We believe the present invention provides methods that are low cost and easy to adapt. These low barrier methods can compete with oil in price, and they are very convenient in practical applications. Using motion cells to collect wave energy as illustrated in FIG. 6 and FIGS. 9(a-c) not only can generate electrical power, the motion cells also can absorb wave energy. Therefore, they can make a vehicle carrying motion cell more comfortable. A large number of floating motion cells can calm down wild waves, and serve as shield against dangerous waves. If the area is large enough, such motion cells can reduce the power of natural disasters such as hurricanes or tsunamis. Comparing to other electrical power generators, methods of the present invention can be designed to be environmental friendly. Of course, absorbing energy from natural environment may cause unforeseen effects even when carefully designed with good intentions. The present invention has the advantage of being highly mobile so that we can easily remove or change the structure to make it more environmentally friendly when unforeseen problems are found. It is our hope that motion cells can help human beings burn less oil, build fewer dams, abandon nuclear power plants, and use energy-efficient batteries to make this beautiful planet a better place to live.

While specific embodiments of the invention have been illustrated and described herein, it is realized that other modifications and changes will occur to those skilled in the art. It is therefore to be understood that the appended claims are intended to cover all modifications and changes as fall within the true spirit and scope of the invention.

What is claimed is:

1. An electrical power generator comprising: (a) field terminal(s) for holding electrical charges to generate electrical fields, (b)collector terminal(s) that react(s) to the electrical fields of said field terminal(s) to generate electrical power from the relative motion between said collector terminal(s) and field terminal(s).

2. The electrical power generator in claim 1 comprises a rectifier circuitry.

3. The electrical power generator in claim 1 is placed into a container that is compatible with existing battery.

4. The electrical power generator in claim 1 is configured to charge a rechargeable battery.

5. The electrical power generator in claim 1 is placed into a buoy to convert wave energy into electrical energy.

6. The electrical power generator in claim 1 converts sound waves into electrical energy.

7. The electrical power generator in claim 1 converts changes in pressure into electrical energy.

8. The electrical charges on the field terminal(s) of the electrical power generator in claim 1 is generated by applying a voltage on the field terminal(s).

9. The electrical charges on the field terminal(s) of the electrical power generator in claim 1 are built-in charges.

10. A method for manufacturing electrical power generator comprising the steps of: (a) providing field terminal(s) for holding electrical charges to generate electrical fields, (b) providing collector terminal(s) that react(s) to the electrical fields of the field terminal(s) to generate electrical power from the relative motion between collector terminals and field terminal(s).

11. The method in claim 10 comprising the step of connecting collector terminals to the inputs of a rectifier circuitry.

12. The method in claim 10 comprising the step of placing the electrical power generator into a container that is compatible with existing batteries.

13. The method in claim 10 comprising the step of configuring the electrical power generator to charge a rechargeable battery.

14. The method in claim 10 comprising the step of placing the electrical power generator into a buoy to convert wave energy into electrical energy.

15. The method in claim 10 comprising the step of using the electrical power generator to convert sound waves into electrical energy.

16. The method in claim 10 comprising the step of using the electrical power generator to convert changes in pressure into electrical energy.

17. The method in claim 10 comprising the step of applying a voltage to the field terminal(s) of the electrical power generator to generate charges on said field terminal(s).

18. The method in claim 10 comprising the step of placing built-in charges into the field terminal(s) of the electrical power generator.
